(19) United States
(12) Patent Application Publication
(10) Pub. No.: US 2012/0155004 A1
(43) Pub. Date: Jun. 21, 2012

(54) INFORMATION PROCESSING DEVICE

(75) Inventors: Shuhei Yukawa, Nagano (JP); Masayoshi Koganei, Tokyo (JP); Kazuaki Takahashi, Saitama (JP)

(73) Assignee: SONY CORPORATION, Tokyo (JP)

(21) Appl. No.: 13/314,619

(22) Filed: Dec. 8, 2011

(30) Foreign Application Priority Data
Dec. 17, 2010 (JP) P2010-281640

(51) Int. Cl. G06F 1/16

(52) U.S. Cl. 361/679.21

(57) ABSTRACT

An information processing device includes a housing, a display, an auxiliary storage, a main storage, and a lid. The housing is formed with an opening in a back surface thereof. The display is provided on the front side of the housing. The auxiliary storage is contained in the housing so as to be exposed via the opening. The main storage is contained in the housing so as to be exposed via the opening. The lid can be attached to and detached from the opening.

### BACKGROUND

The present technology relates to an information processing device of an integral display type.

A personal computer (hereinafter abridged to “PC”) has mounted thereon such modules as an HDD (Hard Disk Drive), a memory, an optical disk drive, etc. For displacement and extension, these modules are so configured that they can be attached and detached by the user. In notebook-sized personal PCs and integral display type PCs, in general, a housing is provided with an opening for exposing each module therethrough, and the opening is closed with a detachable lid.

For example, Japanese Patent Laid-Open No. 2000-22347 (paragraph [0017], FIG. 6) (hereinafter referred to as Patent Document 1) discloses an information processing device provided with an opening section for extension of memory. The opening section is provided in the back surface of the housing in the vicinity of the memory, and an opening for access to another module such as a hard disk drive is provided separately from the opening section.

### SUMMARY

In the information processing device as described in Patent Document 1, however, for access to a plurality of modules it may be necessary to respectively remove the lids at the openings for access to the modules, so that operations of making access to the modules are bothersome. Besides, in the manufacturing process also, the lids have to be respectively attached to the openings for access to the modules, leading to a lowered productivity. Further, the plurality of lids disposed at the housing may deteriorate the external appearance of the information processing device.

Thus, there is a need for an information processing device which is excellent in maintainability and external appearance and which has a reduced number of component parts.

According to an embodiment of the present technology, there is provided an information processing device which includes a housing, a display, an auxiliary storage, a main storage, and a lid.

The housing is formed with an opening in a back surface thereof.

The display is provided on the front side of the housing.

The auxiliary storage is contained in the housing so as to be exposed through the opening.

The main storage is contained in the housing so as to be exposed through the opening.

The lid can be attached to and detached from the opening.

According to this configuration, since the auxiliary storage and the main storage are disposed inside the housing so as to be exposed through the opening, the user can get access to the auxiliary storage and the main storage by opening the lid at the opening. Therefore, the information processing device is superior in maintainability to an information processing device wherein access openings and lids are provided respectively for an auxiliary storage and a main storage. In addition, since it is necessary only to provide one opening and one lid, the information processing device can be made to have excellent external appearance and a reduced number of component parts.

The information processing device may further have a disk drive which can be attached to and detached from the housing by sliding relative to the housing, with a screw hole for fixing the disk drive to the housing being provided so as to be exposed through the opening.

According to this configuration, the user can detach the disk drive from the housing by opening the lid at the opening, removing a screw used to fix the disk drive to the housing, and sliding the disk drive.

The information processing device may further have a radio communication unit contained in the housing so as to be exposed through the opening, and the lid may have a metallic plate formed with a cutout in a region opposed to the radio communication unit.

According to this configuration, a metallic plate as the lid or as part of the lid is disposed for securing mechanical strength of the housing or for coping with radiation or the like purpose, but the cutout ensures that electromagnetic waves transmitted from and received by the radio communication unit are not blocked.

The information processing device may have a configuration in which the lid has a first plate member fixed to the housing and a second plate member which can be attached to and detached from the first plate member, the first member has an arm connecting section to which a wall hanging arm operable to support the housing is connected, and the second member has a stand operable to support the housing.

According to this configuration, a support structure for the information processing device can be changed from the stand to the wall hanging arm, by detaching the second member connected with the stand from the information processing device and connecting the wall hanging arm to the first member.

The information processing device may further have a power supply jack formed along a second direction inclined relative to a first direction perpendicular to a first plane parallel to the display, and the power supply jack may be hidden by the stand on the back side of the housing when the second plate member is fixed to the first plate member.

According to this configuration, it can be ensured that a power supply plug inserted in the power supply jack is less liable to be disengaged, even when a force in the first direction is exerted thereon. In addition, with the power supply jack disposed at such a position as to be hidden behind the stand, a power supply cord connected to the power supply plug can be hidden and, hence, the information processing device can be made excellent in external appearance.

Thus, according to an embodiment of the present technology, it is made possible to provide an information processing device which is excellent in maintainability and external appearance and which has a reduced number of component parts.

### BRIEF DESCRIPTION OF THE DRAWINGS

FIG. 1 is a front view showing an external appearance of a PC according to an embodiment of the present technology;

FIG. 2 is a back view showing an external appearance of the PC;

FIG. 3 is a left side view showing an external appearance of the PC;

FIG. 4 is a right side view showing an external appearance of the PC;

FIG. 5 is a plan view showing an external appearance of the PC;

FIG. 6 is a bottom view showing an external appearance of the PC;

FIG. 7 is a perspective view showing a state in which a stand of the PC has been detached;

FIG. 8 is a block diagram of a module mounted on the PC;

FIG. 9 is a schematic diagram showing the layout of modules of the PC;

FIG. 10 is a back view showing a housing in the state where a lid of the PC has been detached;

FIG. 11 is a perspective view of a disk drive of the PC;

FIG. 12A shows a bottom surface of a disk drive, FIG. 12B shows a right side surface of the same, FIG. 12C shows a left side surface of the same, FIG. 12D shows a front surface of the same, and FIG. 12E shows a back surface of the same;

FIG. 13 is a perspective view of the disk drive being slid relative to the housing of the PC;

FIG. 14 is a plan view showing a state in which the disk drive of the PC is inserted in the housing;

FIG. 15 is a back-side perspective view of the lid and the stand of the PC;

FIG. 16A is a top view of the lid, FIG. 16B is a front view of the same, and FIG. 16C is a bottom view of the same;

FIG. 17A is a left side view of the lid, FIG. 17B is a back view of the same, and FIG. 17C is a right side view of the same;

FIG. 18 is a plan view of a second member of the PC;

FIG. 19 is a perspective view showing a state in which the second member of the PC is used as a mount;

FIG. 20 is a sectional view showing an inclination angle of a power supply jack of the PC;

FIG. 21 is a perspective view showing a power supply jack bracket of the PC;

FIG. 22 is a perspective view of the power supply jack bracket of the PC;

FIG. 23A is a top view of the power supply jack bracket, FIG. 23B is a back view of the same, FIG. 23C is a bottom view of the same, FIG. 23D is a left side view of the same, and FIG. 23E is a right side view of the same; and

FIG. 24A is a view of the power supply jack bracket as viewed from a lateral side, and FIG. 24B is a view of the power supply jack bracket as viewed from the upper side.

### DETAILED DESCRIPTION OF THE PREFERRED EMBODIMENT

Now, referring to the drawings, a personal computer according to an embodiment of the present invention will be described below.

### [General Configuration of Personal Computer]

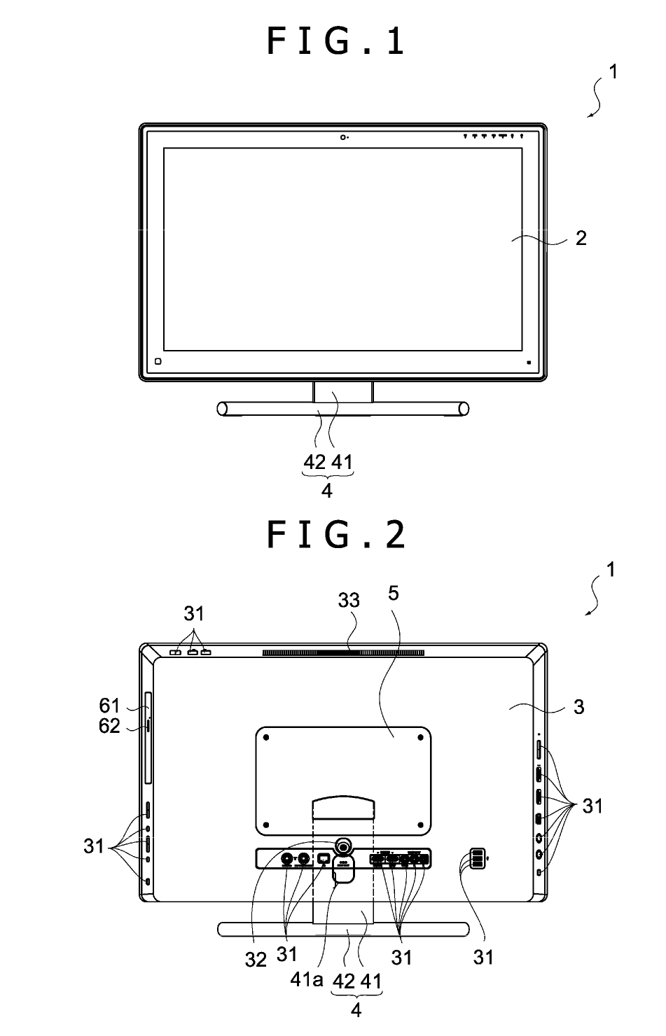

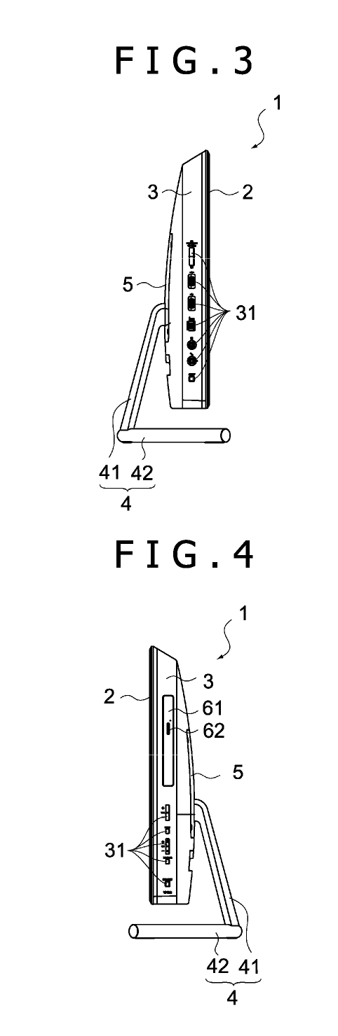

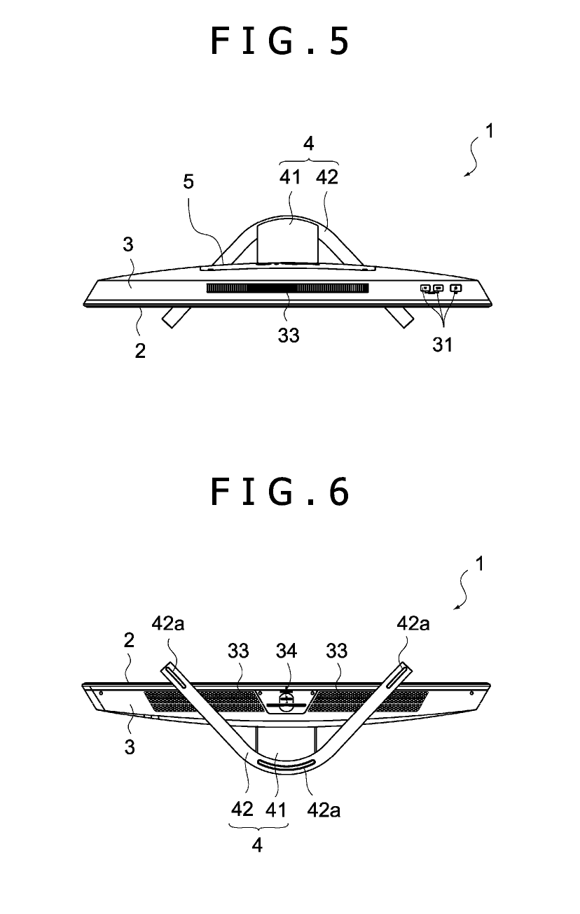

FIGS. 1 to 6 are views each showing an external appearance of the personal computer (hereinafter abridged to “PC”) 1 according to the present embodiment. The PC 1 is an integral-type PC in which a display and a computer are configured integrally. FIG. 1 is a front view of the PC 1 (based on directions as the PC 1 is viewed from the display side, here and hereafter), FIG. 2 is a back view of the PC 1, FIG. 3 is a left side view of the PC 1, FIG. 4 is a right side view of the PC 1, FIG. 5 is a plan view (top plan view) of the PC 1, and FIG. 6 is a bottom view of the PC 1.

As shown in FIGS. 1 to 6, the PC 1 includes a display 2, a housing 3 and a stand 4. The display 2 is provided on the front surface of the housing 3. Incidentally, in the following description, the display 2 and the housing 3 will be referred to as a PC body. The stand 4 is connected to the housing 3, to support the PC body. Incidentally, in FIG. 2, a part of the stand 4 is represented in perspective view.

The display 2 can be any display, such as an LCD (Liquid Crystal Display), a plasma display, an OELD (Organic Electro-Luminescence Display), etc.

The housing 3 contains modules of the PC 1 therein. The modules contained in the housing 3 will be described in detail later. The housing 3 is provided with groups of switches 31, for example, external connection terminals such as USB (Universal Serial Bus) ports, audio output terminals, a LAN (Local Area Network) cable port, etc., various switches such as a power switch, a volume control switch, etc., and, further, lamps indicative of operating conditions of the PC 1.

The groups of switches 31 are provided on the back surface, both side surfaces and the top surface of the housing 3. The top surface and the bottom surface of the housing 3 are provided with slits for discharging heat from the inside of the housing 3. While details will be described later, a power supply jack 32 is provided on the back surface of the housing 3. In the configuration of the housing 3, the layout of the groups of switches 31 and the slits 33 may be set arbitrarily and can be changed as required. In addition, the bottom surface of the housing 3 is provided with a card insertion port 34 for restricted reception of digital television broadcasting.

A lid 5 is provided at a central portion of the back surface of the housing 3. As will be detailed later, the lid 5 is closing an opening (not shown in FIG. 2) provided in the housing 3. A stand 4 is connected to the lid 5, and the housing 3 is supported by the stand 4 through the lid 5.

A front panel 61 of a disk drive contained in the housing 3 is provided at a right side surface of the housing 3. The disk drive is a disk tray type disk drive, and the front panel 61 is connected to a disk tray of the disk drive. The front panel 61 is provided with a switch 62 for opening and closing the disk tray. With the switch 62 operated, the front panel 61 is drawn out from the side surface of the housing 3 together with the disk tray. The layout of the disk drive inside the housing 3 will be described later. Incidentally, the position of the front panel 61 is not restricted to the right side surface of the housing 3 but may be a left side surface or a top surface of the housing 3 according to the layout of the disk drive.

The stand 4 has a stand neck 41 and a stand leg 42. The stand neck 41 is a portion for interconnecting the housing 3 and the stand leg 42. The stand neck 41 is provided with a hole 41a for laying around various cables. The cables are passed through the hole 41a from the back surface of the housing 3, and laid around to the back side of the stand neck 41. The stand leg 42 is a portion placed on a mount surface, and cushion members 42a are provided respectively at both left and right ends and a central part of the stand leg 42.

[In regard of Opening in Back Surface of Housing]

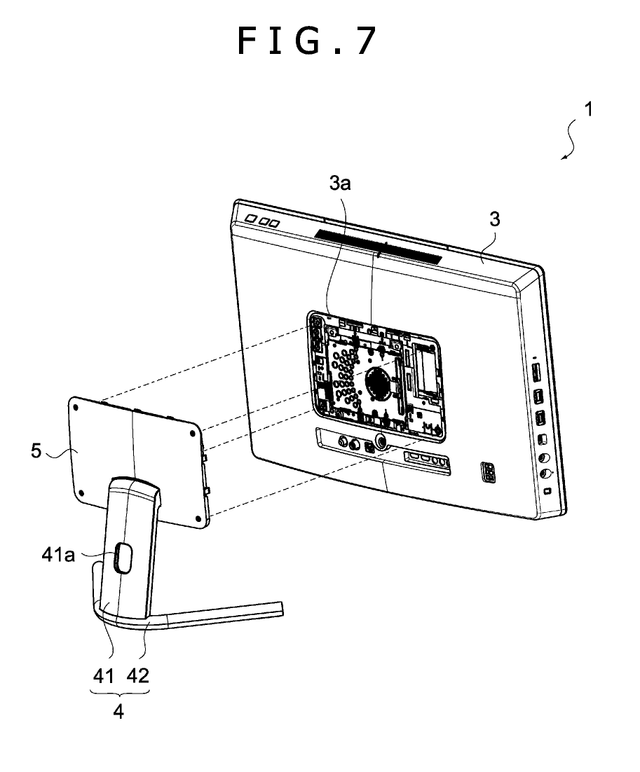

The back surface of the housing 3 is provided in its central portion with the opening, as above-mentioned, and the opening can be closed with the lid 5 which can be attached to and detached from the opening. FIG. 7 is a perspective view showing the PC 1 in the state in which the lid 5 has been detached from the housing 3, together with the stand 4 connected to the lid 5.

As shown in the figure, when the lid 5 and the stand 4 connected to the lid 5 are detached from the housing 3, the opening 3a formed in the central portion of the back surface of the housing 3 is opened. The lid 5 may be one that is fixed to the housing 3 by screws, for example. The opening 3a is formed in the same size as the outer periphery of the lid 5.

### [Internal Configuration of Personal Computer]

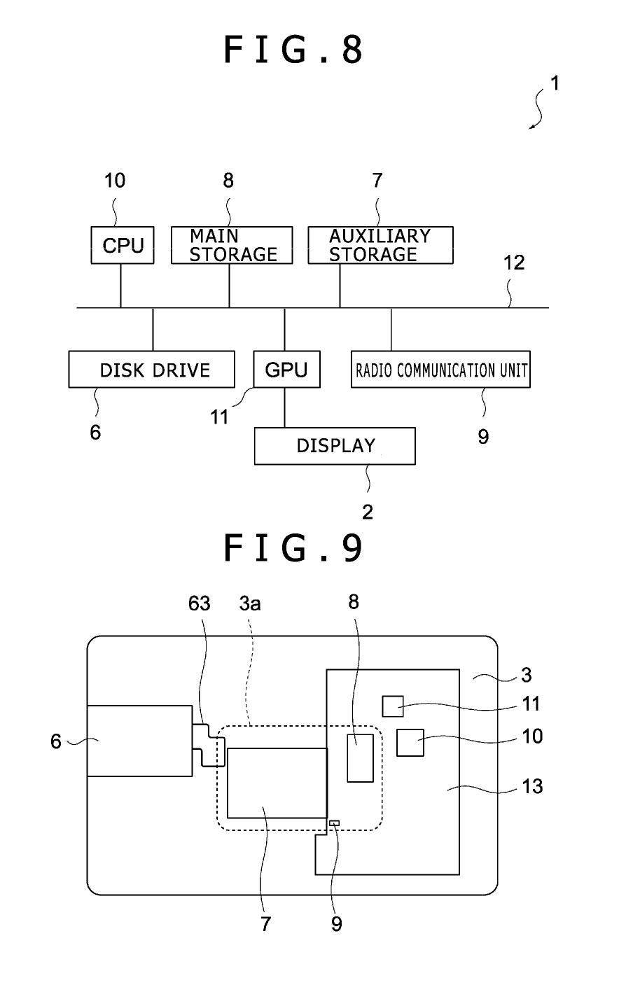

FIG. 8 is a block diagram showing modules mounted on the PC 1.

As shown in the figure, the disk drive 6, an auxiliary storage 7, a main storage 8, a radio communication unit 9, a central processing unit (hereinafter abridged to “CPU”) 10, and a graphics processing unit (hereinafter abridged to “GPU”) 11 are mounted on the PC 1. These modules are interconnected through a bus 12, and a display 2 is connected to the GPU 11. Incidentally, other than these modules, a power supply unit and speakers and the like (not shown) are also mounted on the PC 1.

The CPU 10 totally controls the above-mentioned sections, and controls transfer of data between the sections. In addition, for executing software processes, the CPU 10 loads programs from the auxiliary storage 7 into the main storage 8, interprets the programs, and executes the programs. The CPU 10 may be a microprocessor.

The main storage 8 is a storage in which the program to be arithmetically processed and work data for the program are temporarily stored. The main storage 8 may be, for example, a DRAM (Dynamic Random Access Memory).

The auxiliary storage 7 is a storage in which program codes, contents data and the like are permanently stored. The auxiliary storage 8 may be an HDD (Hard Disk Drive) or an SSD (Solid State Drive).

The GPU 11 executes an image drawing process, and outputs the results of the process to the display 2. The GPU 11 may be a microprocessor. Incidentally, the GPU 11 may be substituted by the CPU 10.

The radio communication unit 9 performs communications with external apparatuses connected to the PC 1, such as a mouse and a keyboard. The radio communication unit 9 is connected to these external apparatuses according to arbitrary radio communication standards.

The disk drive 6 is a drive for removable disks such as optical disc and magnetic disk, e.g., BD (Blu-ray Disc) or DVD (Digital Versatile Disc). The disk drive 6 reads the contents of a disk set therein or writes data into the disk.

### [Layout of Modules]

The layout of the above-mentioned modules inside the housing 3 will now be described.

FIG. 9 is a schematic diagram showing the layout of the modules, as viewed from the back side of the PC 1. In the figure, the opening 3a of the housing 3 is indicated by broken line.

As shown in the figure, the auxiliary storage 7, the main storage 8 and the radio communication unit 9 are laid out at positions facing the opening 3a. Incidentally, the main storage 8, the radio communication unit 9, the CPU 10 and the GPU 11 are disposed on a mother board 13. The auxiliary storage 7, the main storage 8 and the radio communication unit 9 are so disposed that they, not partially but entirely, face the opening 3a.

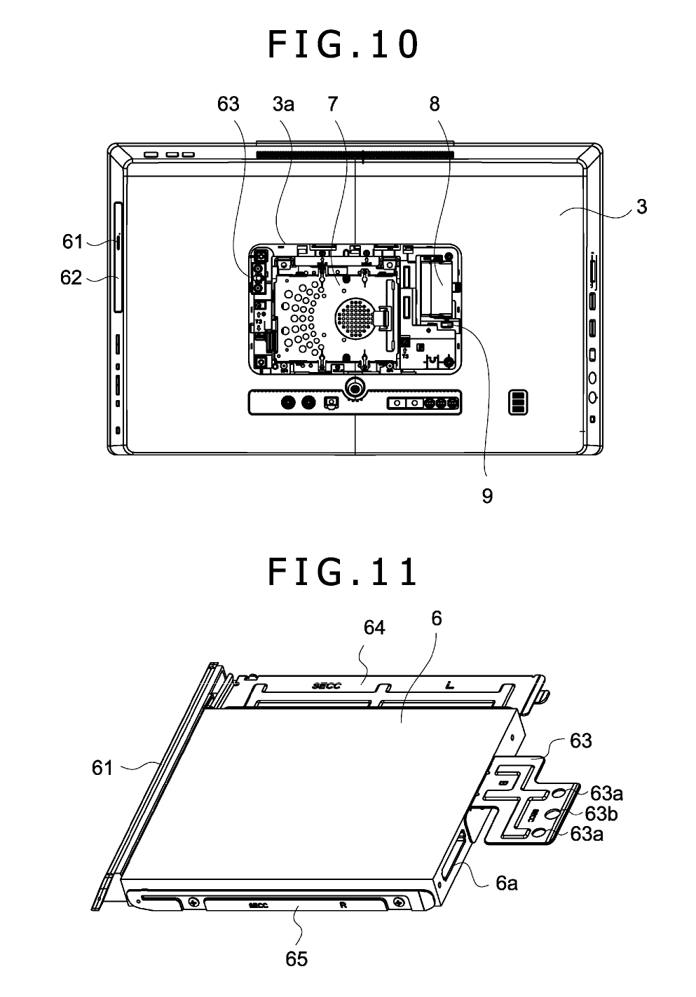

FIG. 10 is a plan view showing the housing 3 in the state in which the lid 5 has been detached. As shown in the figure, the auxiliary storage 7, the main storage 8 and the radio communication unit 9 are exposed through the opening 3a, so that replacement of each of these modules can be carried out. Therefore, a module replacing operation is facilitated, as compared with the case where openings and lids are provided individually for the modules.

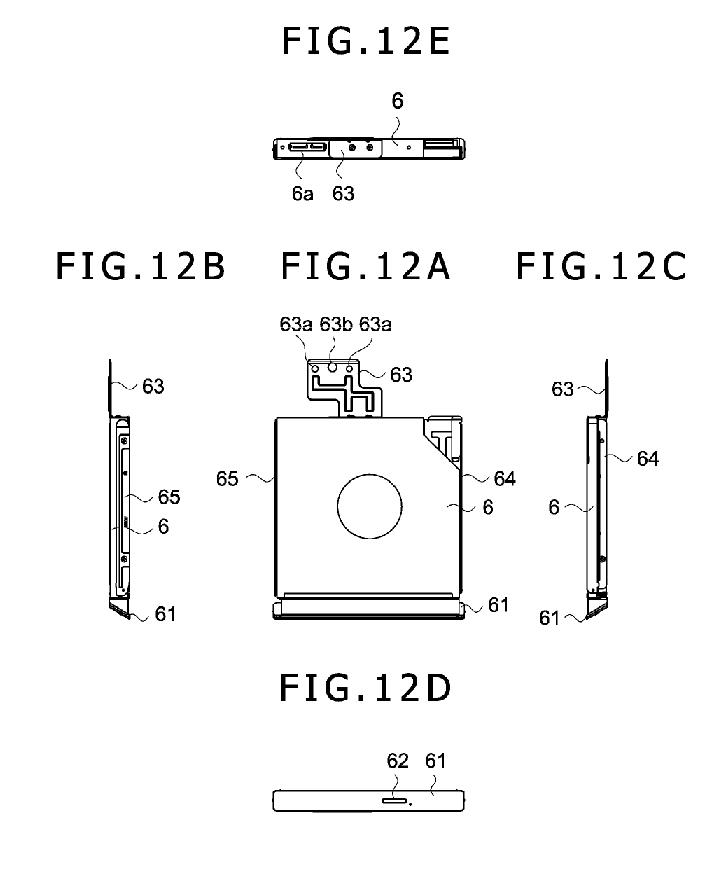

In addition, the disk drive 6 is so disposed that a part of a back surface bracket 63 provided in the disk drive 6 faces the opening 3a. FIG. 11 is a perspective view showing the disk drive 6, and FIGS. 12A to 12E show a plan view and the like of the disk drive 6. Taking the side on which the front panel 61 is provided as the front side, FIG. 11 is a perspective view of the disk drive 6 as viewed from the upper side, FIG. 12A shows a bottom surface of the disk drive 6, FIG. 12B shows a right side surface of the same, FIG. 12C shows a left side surface of the same, FIG. 12D shows a front /surface of the same, and FIG. 12E shows a back surface of the same.

As shown in these figures, the back surface bracket 63, a left side surface bracket 64 and a right side surface bracket 65 are connected to the disk drive 6. The back surface bracket 63 is connected to the back surface of the disk drive 6, and is extended from the back surface of the disk drive 6. The back surface bracket 63 is provided with two screw holes 63a and a taking-out hole 63b. The taking-out hole 63b is a through-hole formed in the back surface bracket 63, and is utilized for taking out the disk drive 6 which will be described later.

The left side surface bracket 64 is connected to the left side surface of the disk drive 6, and the right side surface bracket 65 is connected to the right side surface of the disk drive 6. In addition, a connector 6a is formed at the back surface of the disk drive 6.

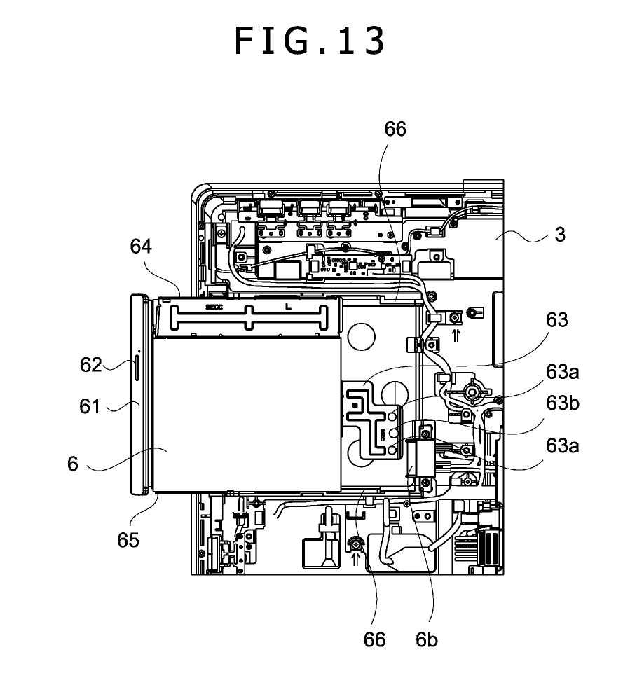

The disk drive 6 is slidingly inserted into the housing 3 from a lateral side of the housing 3. FIG. 13 is a perspective view of the disk drive 6 being slidingly inserted into the housing 3. As shown in the figure, the housing 3 is provided with slide rails 66 respectively at positions facing both side surfaces of the disk drive 6. The disk drive 6 is slid in the state in which the left side surface bracket 64 and the right side surface bracket 65 are inserted in the slide rails 66 faced by them, respectively. The housing 3 is provided with a housing-side connector 6b at a position corresponding to the connector 6a.

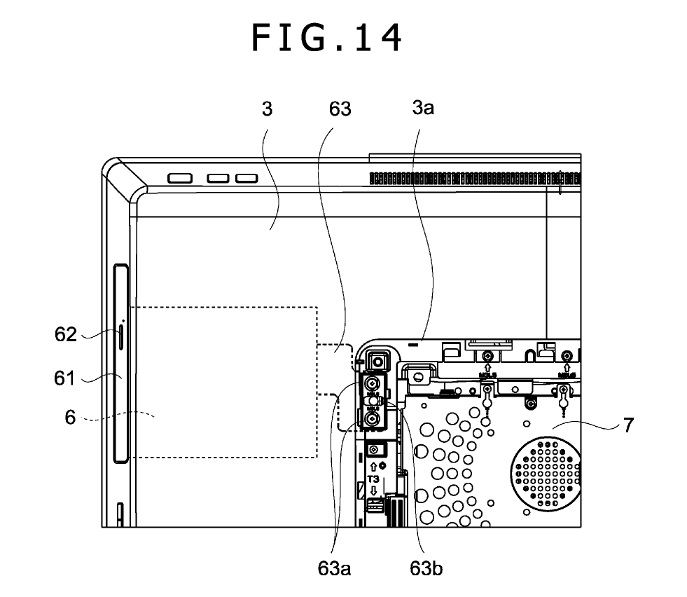

FIG. 14 is a plan view showing a state in which the disk drive 6 is completely inserted in the housing 3. As shown in the figure, when the disk drive 6 is completely inserted in the housing 3, the screw holes 63a and the taking-out hole 63b in the back surface bracket 63 are exposed via the opening 3a. The back surface bracket 63 is fixed to the housing 3 by being screwed through the screw holes 63a. In FIG. 14, screws passed through the screw holes 63a are shown. Besides, in this instance, the connector 6a is fitted to the housing-side connector 6b, and the disk drive 6 is electrically connected to the housing 3.

Thus, after being inserted into the housing 3 in a sliding manner, the disk drive 6 is fixed by use of the screw holes 63a exposed via the opening 3a. Therefore, fixation of the disk drive 6 can be carried out by removing the lid 5 only.

At the time of taking the disk drive 6 out of the housing 3, first, the screws passed through the screw holes 63a are removed. Next, a tool or the like is inserted into the taking-out hole 63b, and is pushed out in the sliding direction of the disk drive 6, whereby the disk drive 6 can be slid and taken out of the housing 3. In this way, attachment and detachment of the disk drive 6 can be carried out utilizing the screw holes 63a and the taking-out hole 63b which are exposed via the opening 3a.

### [In Regard of Lid]

Details of the lid 5 will now be described.

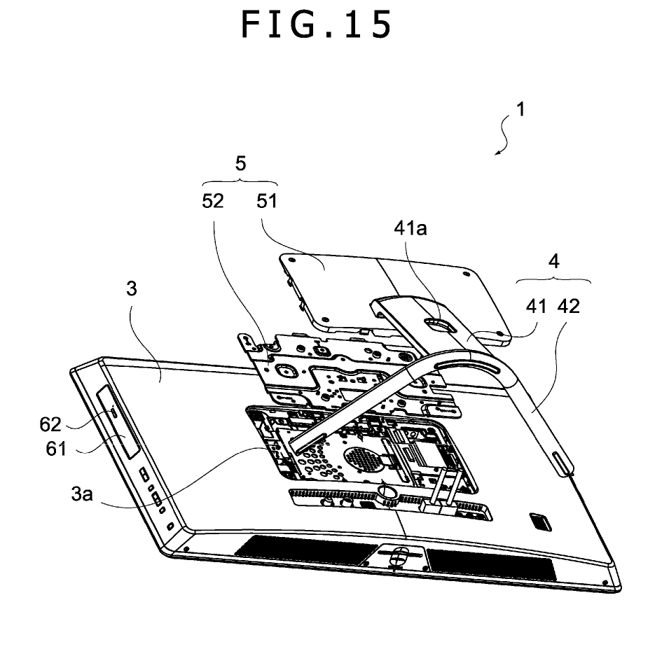

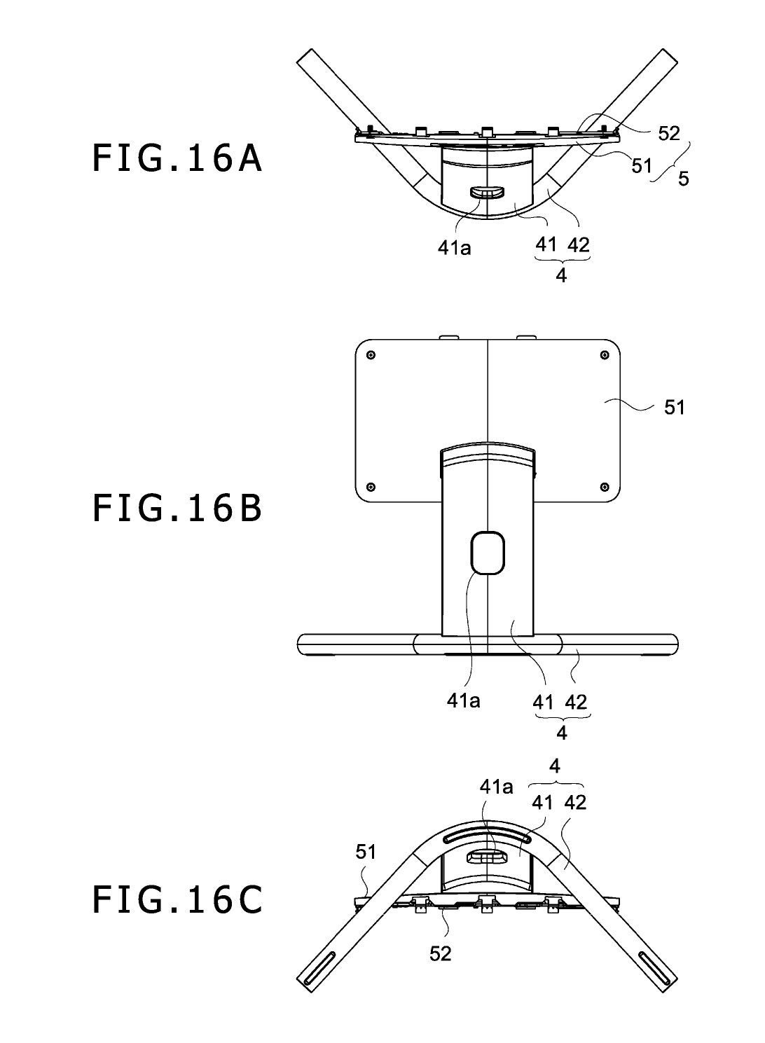

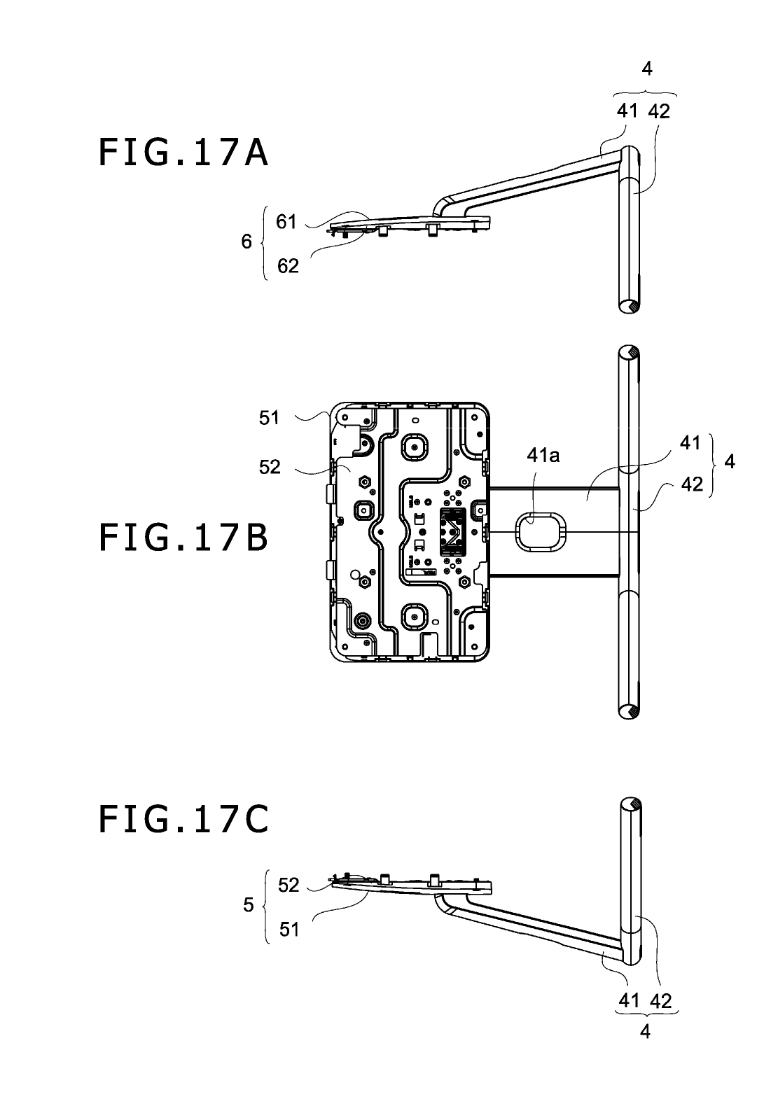

FIG. 15 is a perspective view showing the lid 5 and the stand 4 which have been separated from the housing 3. FIGS. 16A to 17C show plan views and the like showing the lid 5 and the stand 4. Taking the surface of the lid 5 as viewed from the back side of the PC 1 as a front surface and taking the surface facing the housing 3 as a back surface, FIG. 16A is a top view of the lid 5, FIG. 16B is a front view of the same, and FIG. 16 is a bottom view of the same. FIG. 17A is a left side view of the lid 5, FIG. 17B is a back view of the same, and FIG. 17C is a right side view of the same.

As shown in these figures, the lid 5 includes a first member 51 on the front side and a second member 52 on the back side. The first member 51 is formed from a material by which electromagnetic waves are not easily blocked, such as synthetic resin. The first member 51 has the same shape as the inner periphery of the opening 3a so that the opening 3a can be closed with the first member 51. The second member 52 is formed from a metal, for securing mechanical strength of the housing 3 and for coping with radiation. The second member 52 is roughly the same as the first member 51 in shape. The second member 52 is fixed to the housing 3 by the same screws as used for the first member 51, in such a manner that both the first member 51 and the second member 52 are disengaged from the housing 3 when the screws are removed.

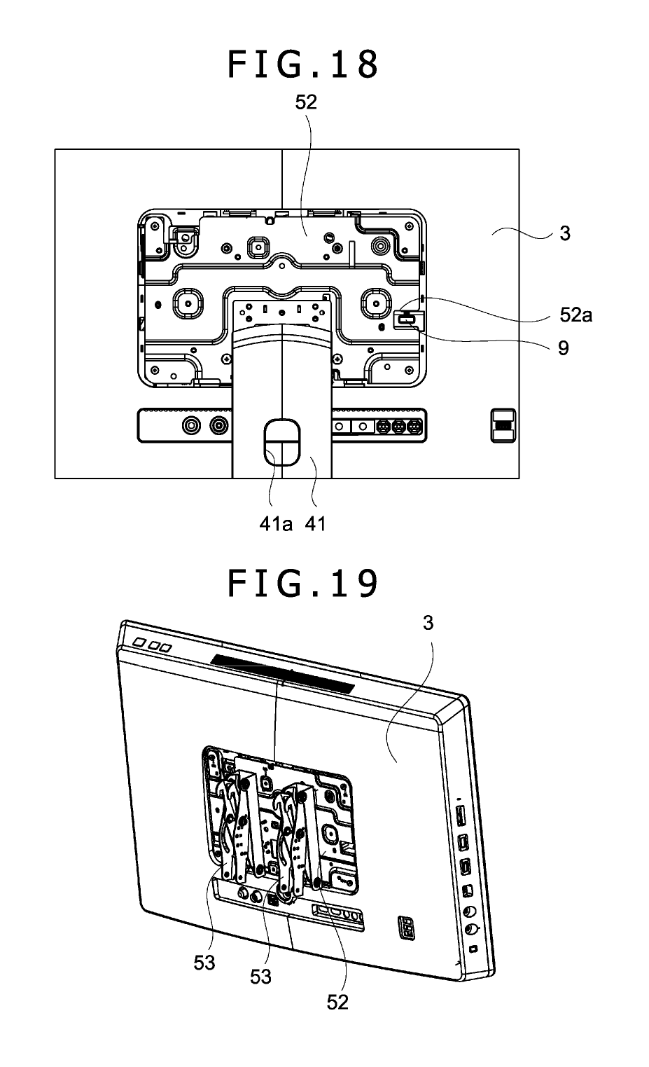

FIG. 18 is a plan view showing the second member 52. In the figure, the first member 51 is omitted. As shown in the figure, the second member 52 is provided with a cutout 52a. The cutout 52a is so formed that the radio communication unit 9 is exposed therethrough in the condition in which the second member 52 is attached to the housing 3. This ensures that electromagnetic waves received by or transmitted from the radio communication unit 9 are not blocked by the second member 52.

In addition, the second member 52 can be used as a mount for mounting wall hanging arms. FIG. 19 is a perspective view showing the PC 1 in the condition where the second member 52 is used as a mount. As shown in the figure, the second member 52 is so configured that the wall hanging arms 53 can be connected thereto. The wall hanging arms 53 may be, for example, arms conforming to the VESA (Video Electronics Standard Association) standard. The second member 52 is formed with mounting screw holes conforming to such an arm standard.

### [In Regard of Power Supply Jack]

The power supply jack 32 provided at the back surface of the housing 3 will now be described.

The power supply jack 32 is a jack for a DC (Direct Current) power supply. As shown in FIG. 2, the power supply jack 32 is provided on the lower side of the lid 5, at a position such as to be hidden behind the stand neck 41. This layout ensures that the power supply jack 32 and a power cord are difficult to see, as viewed from the back side of the PC 1, whereby appearance quality of the PC 1 is enhanced.

In addition, the power supply jack 32 may be formed in a direction inclined relative to the direction orthogonal to a plane parallel to the display 2. In the case where the back surface of the housing 3 is parallel to the display 2, the power supply jack 32 may be formed in a direction inclined relative to the direction orthogonal to the back surface of the housing 3.

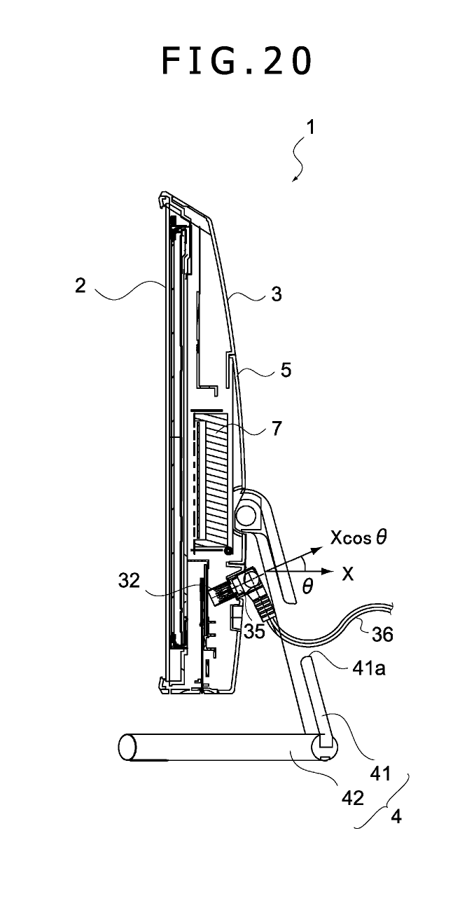

FIG. 20 is a sectional view of the PC 1, showing the inclination angle of the power supply jack 32. The figure shows a power supply plug 35 inserted into the power supply jack 32 as well as the power cord 36 extending from the power supply plug 35. The power cord 36 is passed through the opening 41a in the stand neck 41. As shown in the figure, the inclination direction of the power supply jack 32 is set in a direction toward the bottom surface of the housing 3, specifically, a direction such that the power supply plug 35 is inserted along an oblique downward direction. More specifically, the inclination angle of the power supply jack 32 may be 20° relative to the direction orthogonal to a plane parallel to the display 2. This inclination angle can be selected from the range of 10° to 30°.

With the power supply jack 32 thus inclined, the power supply plug 35 can be prevented from being easily disengaged. As shown in FIG. 20, it is assumed that the power supply cord 36 is pulled and a force X in the direction orthogonal to the plane parallel to the display 2 is exerted on the power supply plug 35. Let the inclination angle of the power supply jack 32 be θ, then the force acting in the disengaging direction of the power supply plug 35 is X cos θ. Where θ is 20°, the force acting in the disengaging direction of the power supply plug 35 is 0.94X, which is smaller than the force X by 6%.

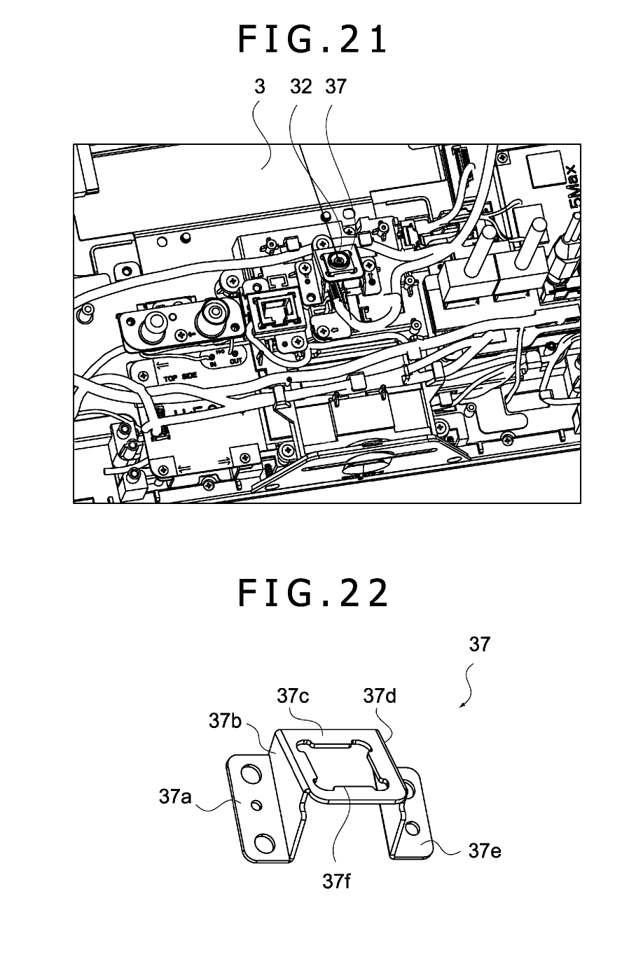

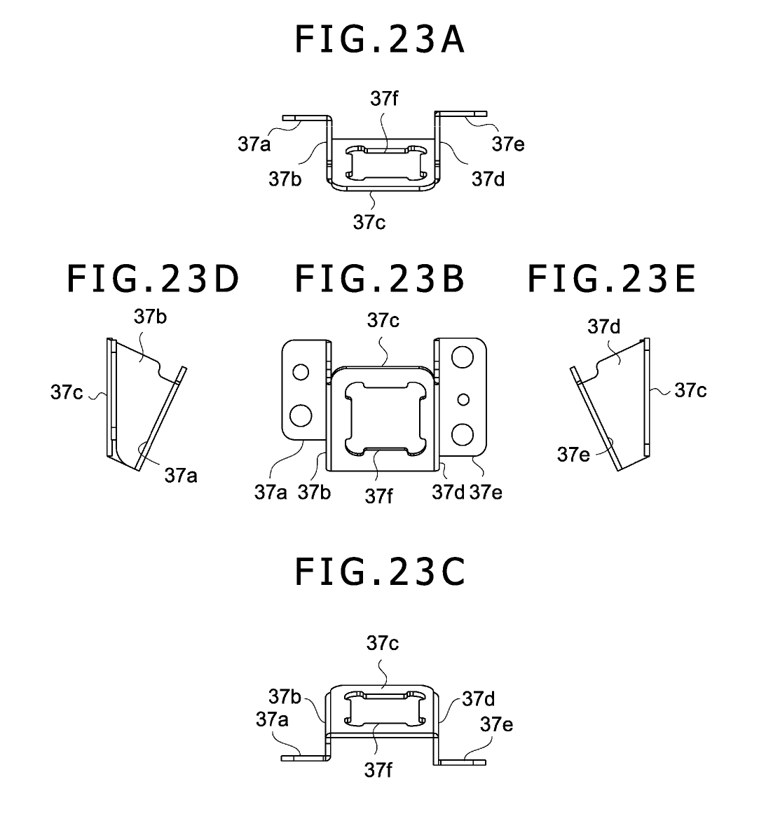

The inclination angle of the power supply jack 32 can be formed by use of a bracket for mounting the power supply jack 32 onto the housing 3. FIG. 21 is a perspective view showing a power supply jack bracket 37 which is fixed to the housing 3 and is used to mount the power supply jack 32. FIG. 22 is a perspective view of the power supply jack bracket 37, and FIGS. 23A to 23E show a plan view and the like of the power supply jacket bracket 37. Taking the surface where the power supply jack 32 is provided as a front surface, FIG. 23A is a top view of the power supply jack bracket 37, FIG. 23B is a back view of the same, FIG. 23C is a bottom view of the same, FIG. 23D is a left side view of the same, and FIG. 23E is a right side view of the same.

As shown in these figures, the power supply jack bracket 37 has a first surface 37a, a second surface 37b, a third surface 37c, a fourth surface 37d and a fifth surface 37e. The third surface 37c is formed with a hole 37f for mounting the power supply jack 32. The first surface 37a and the second surface 37b are continuous with each other; similarly, the second surface 37b and the third surface 37c are continuous, the third surface 37c and the fourth surface 37d are continuous, and the fourth surface 37d and the fifth surface 37e are continuous with each other.

The first surface 37a and the fifth surface 37e are parallel to each other, and they are fixed to the housing 3 by use of screw holes provided respectively therein. Hereafter, a plane parallel to the first surface 37a and the fifth surface 37e will be taken as a fixation plane. The second surface 37b is formed to be perpendicular to the first surface 37a, and the fourth surface 37d is formed to be perpendicular to the fifth surface 37e. The second surface 37b and the fourth surface 37d are so formed that their heights from the fixation plane are gradually decreased toward the upper side. Therefore, the third surface 37c is not parallel to the fixation plane but is inclined so that it is lowered on the upper side.

Since the power supply jack bracket 37 is formed in such a shape, in the case where the fixation plane is parallel to the display 2, the power supply jack 32 is fixed in an inclined state as above-mentioned. In addition, with the power supply jack bracket 37 formed in such a shape, enhancement of the strength of the power supply jack bracket 37 is promised.

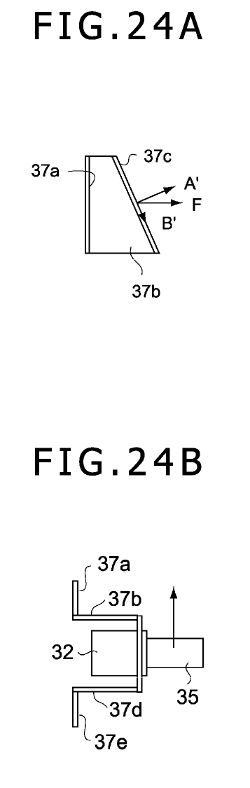

FIGS. 24A and 24B are schematic diagrams showing a force exerted on the power supply jack bracket 37. FIG. 24A is a view of the power supply jack bracket 37 as viewed from a lateral side, and FIG. 24B is a view of the power supply jack bracket 37 as viewed from the upper side. As shown in FIG. 24A, where a force F is exerted on the power supply jack bracket 37 along the direction orthogonal to the fixation plane, the force is dispersed into a tensile stress A′ and a shear stress B′. The shear stress is generally ⅙ times the tensile stress. Therefore, the force exerted on the power supply jack bracket 37 can be deemed as only the tensile stress A′. In other words, in the case where the inclination angle of the third surface 37c is θ, the force A′ exerted on the power supply jack bracket 37 is represented by the following formula (1).

A′=F cos θ=A cos θ (1)

Thus, with the third surface 37c inclined, the force exerted on the power supply jack bracket 37 can be reduced by a factor corresponding to cos θ.

In addition, as shown in FIG. 24B, even in the case where a force is exerted on the power supply plug 35 along a lateral direction, the configuration in which a bending axis is angularly set in the power supply jack bracket 37 ensures that a truss structure is realized, whereby a higher strength can be obtained as compared with the case where the third surface 37c is parallel to the fixation plane.

It should be understood by those skilled in the art that various modifications, combinations, sub-combinations and alterations may occur depending on design requirements and other factors insofar as they are within the scope of the appended claims or the equivalents thereof.

The present technology contains subject matter related to that disclosed in Japanese Priority Patent Application JP 2010-281640 filed in the Japan Patent Office on Dec. 17, 2010, the entire content of which is hereby incorporated by reference.

What is claimed is:

1. An information processing device comprising:
a housing formed with an opening in a back surface thereof;
a display provided on a front side of the housing;
an auxiliary storage contained in the housing so as to be exposed through the opening;
a main storage contained in the housing so as to be exposed through the opening; and
a lid which can be attached to and detached from the opening.

2. The information processing device according to claim 1, further comprising
a disk drive which can be attached to and detached from the housing by sliding relative to the housing, with a screw hole for fixing the disk drive to the housing being provided so as to be exposed through the opening.

3. The information processing device according to claim 1, further comprising
a radio communication unit contained in the housing so as to be exposed through the opening,
wherein the lid has a metallic plate formed with a cutout in a region facing the radio communication unit.

4. The information processing device according to claim 1,
the lid has a first plate member fixed to the housing and a second plate member which can be attached to and detached from the first plate member,
the first member has an arm connecting section to which a wall hanging arm operable to support the housing is connected, and
the second member has a stand operable to support the housing.

5. The information processing device according to claim 1, further comprising
a power supply jack formed along a second direction inclined relative to a first direction perpendicular to a first plane parallel to the display,
wherein the power supply jack is hidden by the stand on the back side of the housing when the second plate member is fixed to the first plate member.
